(19) United States
(12) Patent Application Publication
(10) Pub. No.: US 2016/0123064 A1
(43) Pub. Date: May 5, 2016

(54) DOOR DRIVE

(71) Applicant: DORMA Deutschland GmbH, Ennepetal (DE)

(72) Inventors: Martin WAGNER, Ennepetal (DE); Sven BUSCH, Ennepetal (DE)

(21) Appl. No.: 14/926,895

(22) Filed: Oct. 29, 2015

(30) Foreign Application Priority Data
Oct. 31, 2014 (DE) 10 2014 115 932.2

(51) Int. Cl. E05F 15/603; H02K 11/33

(52) U.S. Cl. CPC E05F 15/603; H02K 11/33

(57) ABSTRACT

A door drive having a drive unit includes at least one electrical drive, an output, which can be driven by the electrical drive and connected to the transmission device for displacing the door leaves, a control device, and a support element. The support element includes recesses, in which the electrical drive, output, and control device are disposed. Alternatively, the drive unit includes a control device having two printed circuit cards, wherein at least the first card partially overlaps the electrical drive and is disposed vertically to its longitudinal axis. The door drive includes a drive profile and at least one drive unit affixed thereto having: at least one electrical drive, an output driven by the electrical drive, and a control device, wherein a transmission device is disposed within the drive profile, wherein the door leaves can be supported at the drive profile and moved by the transmission device.

### FIELD

The disclosure relates to a door drive having a drive unit and particularly being applicable to sliding doors.

### BACKGROUND

Drive units for door drives are known from the state-of-the-art. Said drive units are composed of individual components, wherein the individual components are screwed to a common support profile. The components are for example a drive motor, a gear system, a power supply unit or a control system. All said components are affixed next to each other on the support profile and are wired to each other.

Based on the disposition of the components next to each other, this type of drive unit has the disadvantage that a lot of construction space between the components remains unused. Moreover, it is disadvantageous that the individual components cannot be disposed in a flexible manner.

### SUMMARY

Therefore, the present disclosure describes a door drive, which while being simple and inexpensive in manufacturing and mounting offers a safe and reliable operation, and provides a flexible structure.

Housing as the Support

A door drive is provided having a drive unit, wherein the drive unit comprises at least one electrical drive, an output, a control device and a support element. The output is drivable by the electrical drive and is connectable to a transmission device for moving door leaves. In particular, the transmission device may be a belt drive. The support element has a plurality of recesses. The electrical drive, the output and the control device are disposed in the recesses. In this context, a recess is in particular to be understood in that the support element includes cavities and/or holes, which are configured for the reception of the above-mentioned components.

Preferably, the drive unit comprises a power supply unit. The power supply unit is likewise disposed in a cavity of the support element. As an alternative, the power supply unit may be likewise affixed to an external side of the support element. The power supply unit is thereby alternatively insertable into the support element or fittable onto the support element.

Advantageously, the drive unit comprises furthermore a blocking unit. The blocking unit is again disposed in a cavity of the support element or alternatively on an external side of the support element. Just like the power supply unit, as an alternative, the blocking unit is thus insertable into the support element or can be fitted onto the support element.

Preferably, the drive unit is a rectangular body. In this case, a height of the drive unit amounts to a maximum of 120 millimeters for an overall weight of the door leaf to be moved of at least 600 kilograms. In the event the overall weight of the door leaf to be moved amounts to at least 400 kilograms, the drive unit has a height of 90 millimeters maximum. For an overall weight of the door leaf to be moved of at least 240 kilograms, the height of the drive unit amounts to 60 millimeters maximum. The height is in particular a dimension, which, with the mounted drive unit, can be measured vertically or upright to the passage direction of the door leaves. Preferably, a depth of the drive unit amounts to 60 millimeters maximum. The depth is in particular a dimension, by which the mounted drive unit is elevated from a mounting surface, preferably from a wall.

Preferably, the electrical drive has a first stationary axis. Preferably and at the same time, the output has a second stationary axis. The stationary axes allow for a simple, cost efficient and compact structure of the drive unit. Thereby, a space-saving structure, having in particular the above-mentioned dimensions is provided.

In a particularly advantageous embodiment, the first stationary axis and the second stationary axis are attached to the support element. The first stationary axis and the second stationary axis are in particular pressed into the support element and/or screwed to the support element and/or bonded to the support element. The first stationary axis and the second stationary axis are thus linked to the support element in a stable manner. At the same time, the mounting expense of the first stationary axis and the second stationary axis is very little.

It is likewise particularly and preferably intended that the first stationary axis is disposed parallel to the second stationary axis. A center distance between the first stationary axis and the second stationary axis can thus be determined. Preferably, the center distance amounts to at least half of the sum of diameter of the electrical drive and diameter of the output. A compact construction method and a simple structure of the drive unit are thereby realized.

Moreover, the first stationary axis and the second stationary axis are particularly advantageously oriented rectangularly, or essentially rectangularly with regard to a direction of movement of the door leaves. In this context, essentially rectangular is to be understood as including a deviation of up to ten percent of an angle of 90 degrees.

Disposition of the Control Device

Furthermore, a door drive including a drive unit is provided, wherein the drive unit comprises at least one electrical drive, an output, and a control device. The electrical drive includes a longitudinal axis and is advantageously configured to be cylindrical. The output is again driven by the electrical drive and is connectable to a transmission device for moving door leaves. Again, the transmission device is advantageously a belt drive. The control device comprises at least one first printed circuit card and at least one second printed circuit card. In this case, at least the first printed circuit card is disposed vertically with regard to the longitudinal axis of the electrical drive and at least partially overlapping with the electrical drive. In this way an advantageous separation of the tasks of the first printed circuit card and the second printed circuit card is permitted. It is in particular intended that the first printed circuit card assume tasks directly related to the electrical drive.

Advantageously, the first printed circuit card comprises a control for the electrical drive and the second printed circuit card for a logic control. Usually, high currents and high voltages are required for controlling the electrical drive, whereas the logic control requires lower currents and lower voltages. Therefore, the described task sharing of the first printed circuit card and the second printed circuit card allows for an advantageous separation of areas having high electrical capacity and areas having low electrical capacity. Just the first printed circuit card needs to be designed for high electrical capacities.

Preferably, a distance between the first printed circuit card and a rotor of the electrical drive amounts to a maximum of 20 millimeters. In particular the distance amounts to a maximum of 15 millimeters. It is particularly preferred, if the distance amounts to a maximum of 10 millimeters. Advantageously, it is thereby possible to arrange sensors for the electrical drive directly on the first printed circuit card. This arrangement allows for a space saving design of the electrical drive, because the latter does not require any own sensors. Therefore, all sensors for the electrical drive can be disposed in a space-saving manner on the first printed circuit card. Such sensors include Hall-sensors for detecting a current orientation of the rotor.

Preferably, the first printed circuit card is connected to the second printed circuit card via a contacting element. In particular the contacting element is a plug-in element. Thereby, the first printed circuit card and the second printed circuit card can be provided independently of each other and mountable in the drive unit, wherein a connection of the first printed circuit card and the second printed circuit card is ensured via the contacting element.

Finally and preferably, the drive unit comprises a power supply unit. Thereby, the first printed circuit card is advantageously disposed between the second printed circuit card and the power supply unit. This arrangement allows for particularly short transmission paths for the electrical currents, such that long lines for transferring high electrical power or voltages do not have to be mounted on the first printed circuit card and/or on the second printed circuit card.

Disposition of the Drive Unit at the Profile

Ultimately, a door drive is provided having a drive profile and at least one drive unit affixed to the drive profile. The drive unit comprises at least one electrical drive, an output and a control device. The electrical drive includes a longitudinal axis and is in particular cylindrically configured. The output can be driven by means of the electrical drive. A transmission device, which can be driven by means of the output, is disposed within the drive profile. The transmission device includes a belt. Moreover, the door leaves can be supported at the drive profile and are displaceable by means of the transmission device. An overall depth of the door drive amounts to a maximum of 160 millimeters, preferred to a maximum of 70 millimeters. The door drive with the overall depth of a maximum of 160 millimeters is in particular considered a standard drive. The door drive with the overall depth of a maximum of 70 millimeters is in particular considered a hospital drive. The overall depth is measured in particular parallel with regard to the longitudinal axis and/or vertically with regard to the door leaves. The inventive door drive therefore allows for a very flat construction method. This method provides for a plurality of different design options such as to be able to utilize the door drive in a very flexible manner.

It is preferred, if a first drive unit is affixed to a first end of the drive profile and/or a second drive unit is affixed to a second end of the drive profile. In this case, the first drive unit is in particular designed to be identical to the second drive unit. Thereby, a flexible disposition of the door drive is possible. It is in particular possible to operate two drive units in parallel, whereby load on each of the drive units is reduced. Moreover, this option provides for a redundant system, because in the event of failure of one drive unit, the other drive unit is able to continue to move the door leaves.

Advantageously, a heat-conducting material is inserted between the drive unit and the drive profile. Thereby, the drive profile serves as a heat-conducting body and therefore as a cooling body for the drive unit. Given the size of the drive profile, an optimum cooling of the drive unit is thereby ensured. This circumstance translates in particular into avoiding or at least into retarding any overheating of the electrical drive of the drive unit, even with heavy door leaves.

Preferably, the drive unit is mounted to a frontal side or to a longitudinal side of the drive profile. Mounting to a frontal side allows for a flat structure of the door drive. Mounting to the longitudinal side allows again for a small structure of the door drive. The drive unit is therefore suitable for both possibilities, wherein the installation technician does not have to consider any limiting conditions or restrictions imposed by the drive unit. Moreover, for both options, the control device is preferably oriented towards the installation technician.

With the intention to provide a very filigree door operator, the drive unit and/or the drive profile should raise as little as possible from a mounting surface, in particular from a wall. Therefore, it is preferably intended that a distance between a back side of the drive unit, which side extends parallel to the transmission device, and the transmission device amounts to a maximum of 30 millimeters, in particular to a maximum of 20 millimeters. Such values are in particular achievable with the above-mentioned structure of the drive unit.

In an advantageous embodiment, the drive unit is attached in such a manner to the drive profile, that the control device points away from the drive profile. Thereby, manipulation elements, which serve for adjusting and/or calibrating and/or manipulating the door drive, can be affixed to the control device. Affixing the manipulation elements directly on the control device allows for a space-saving and cost-effective structure, because no additional cables need to be laid.

The disclosure will now be explained in more detail based on one exemplary embodiment. In the Figures:

### BRIEF DESCRIPTION OF THE DRAWINGS

FIG. 1 shows a diagrammatical illustration of a door drive according to a first exemplary embodiment of the disclosure,

FIG. 2 shows a first diagrammatical illustration of a drive unit of the door drive according to the first exemplary embodiment of the disclosure,

FIG. 3 shows a second diagrammatical illustration of the drive unit of the door drive according to the first exemplary embodiment of the disclosure,

FIG. 4 shows a third diagrammatical illustration of the drive unit of the door drive according to the first exemplary embodiment of the disclosure,

FIG. 5 shows a fourth diagrammatical illustration of the drive unit of the door drive according to the first exemplary embodiment of the disclosure,

FIG. 6 shows a diagrammatical illustration of a drive unit of the door drive according to a second exemplary embodiment of the disclosure,

FIG. 7 shows a diagrammatical illustration of a drive unit of the door drive according to a third exemplary embodiment of the disclosure,

FIG. 8 shows a further diagrammatical illustration of the drive unit of the door drive according to the third exemplary embodiment of the disclosure,

FIG. 9 shows a further diagrammatical illustration of the drive unit of the door drive according to the second exemplary embodiment of the disclosure,

FIG. 10 shows a further diagrammatical illustration of the drive unit of the door drive according to the second exemplary embodiment of the disclosure,

FIG. 11: shows a diagrammatical detailed view of the door drive according to a first exemplary embodiment,

FIG. 12 shows an alternative view of the door drive of FIG. 11,

FIG. 13: shows a diagrammatical detailed view of the door drive according to a fourth exemplary embodiment,

FIG. 14 shows an alternative view of the door drive of FIG. 13,

FIG. 15: shows a further diagrammatical illustration of the door drive according to the first exemplary embodiment of the disclosure,

FIG. 16 shows a diagrammatical illustration of a door drive according to a fifth exemplary embodiment of the disclosure,

FIG. 17: shows a diagrammatical illustration of a door drive according to a sixth exemplary embodiment of the disclosure, and

FIG. 18 shows a further diagrammatical illustration of a door drive according to the first exemplary embodiment of the disclosure.

### DETAILED DESCRIPTION OF THE DRAWINGS

Overview on the Door Drive

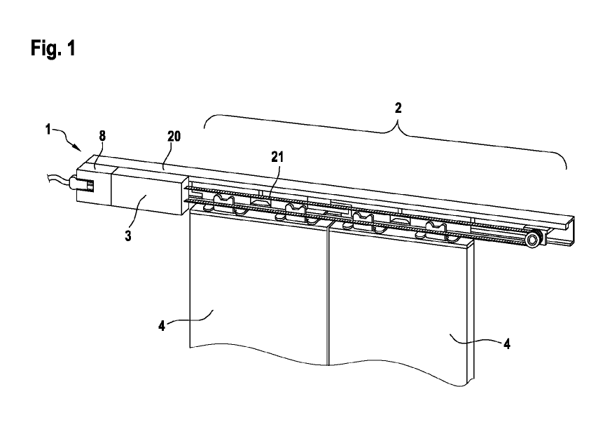

FIG. 1 shows a diagrammatical illustration of a door drive 1 according to a first exemplary embodiment of the disclosure. The door drive 1 comprises a drive unit 3, by means of which electrical energy can be converted into mechanical energy. For the purpose of transferring the mechanical energy, the door drive 1 has a transmission device 2, which is operatively connected to the drive unit 3. In the illustrated exemplary embodiment, the transmission device 2 comprises a belt 21, wherein other embodiments are likewise possible.

The belt 21 of the transmission device 2 allows for displacing the door leaf 4. In particular, the door leaves 4 are linearly moved away from each other and towards each other, in order to realize an opening and closing of a door, which is composed of door leaves 4. For moving the door leaves 4, it is intended the drive unit 3 is supplied with electrical energy from a power supply unit 8 and converts the electrical energy into mechanical energy. The mechanical energy is then transferred by the drive unit 3 onto the transmission device 2, which in turn converts the mechanical energy into the kinetic energy of the door leaves 4. The kinetic energy of the door leaves 4 allows for opening and closing the door.

In the exemplary embodiment shown in FIG. 1, the door drive 1 serves for opening and closing a sliding door. In this case, according to the disclosure, it is likewise intended to utilize the door drive 1 for opening and closing different door types, even if they are not explicitly described.

In the following, various exemplary embodiments of the inventive door drive 1, in particular of the drive unit 3, are described. The individual exemplary embodiments can be combined with each other, such that the different configurations of the drive unit 3 can be utilized as well in the door drive 1 shown in FIG. 1. The exemplary embodiments can be in particular combined among each other.

Overview on the Drive Unit

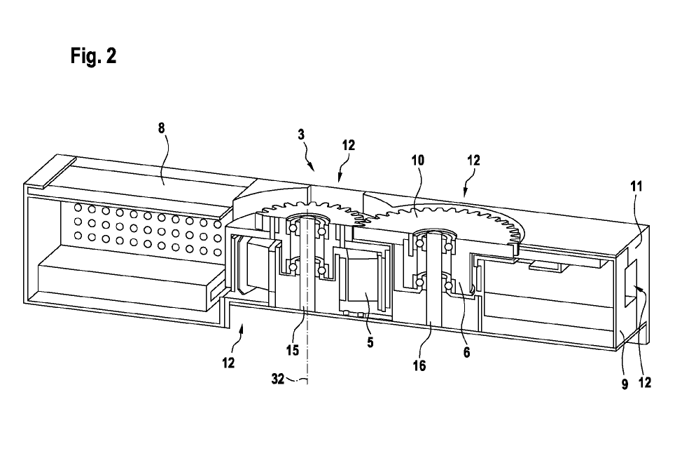

FIG. 2 shows a diagrammatical illustration of a drive unit 3 of the door drive 1 according to the first exemplary embodiment of the disclosure. The drive unit 3 comprises an electrical drive 5, which converts electrical energy into mechanical energy. Preferably, the electrical drive 5 is an electric motor, in particular a brushless electrical motor. It is preferred the electrical motor is a brushless permanently excited electronically commutable motor. The electrical drive has a longitudinal axis 32.

For providing direct current, the drive unit 3 is connected to a power supply unit 8. In FIG. 2, the power supply unit 8 is just diagrammatically illustrated.

The electrical drive 5 is connected to an output via a gear system 10. The output 6 includes a deflection roller, which is connectable to the belt drive 21. The energy is thus transferable from the electrical drive 5 via the gear system 10 onto the deflection roller of the output 6. The deflection roller in turn is able to transfer the energy onto the belt 21, such that the energy necessary to move the door leaves 4 can be provided by the drive unit 3.

Furthermore, the drive unit 3 includes a blocking unit 9. The blocking unit 9 serves to prevent a movement of the door leaves 4, such that the door leaves 4 cannot be opened and/or closed without authorization.

Housing as the Support

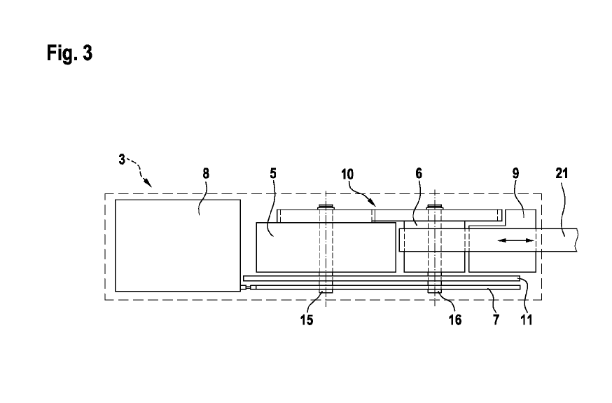

FIG. 3 shows another diagrammatical view of the drive unit 3. It can be seen in this case, that all components of the drive unit 3 are disposed at a support element 11. Preferably, the support element 11 includes a housing, which includes a plurality of recesses. In this case, recess is in particular understood to be a cavity or a through-hole.

A first stationary axis 15, as well as a second stationary axis 16 are attached to the support element 11. In particular, the first stationary axis 15, as well as the second stationary axis 16 are pressed into the support element 11. As an alternative or in addition, a screw connection and/or gluing is/are possible. The first stationary axis 15 serves for supporting the electrical drive 5, whereas the second stationary axis serves for supporting the output 6. Thereby, a shaft-less motor, which is very easy to install, is realized.

Ideally, the first stationary axis 15 and the second stationary axis 16 are disposed parallel to each other. Moreover, the first stationary axis 15 and the second stationary axis 16 are preferably disposed to be vertical to a displacement direction of the door leaves 4. This arrangement allows for maximizing the diameter d of the electrical drive 5, whereby a very high torque can be produced. Therefore, the gear system 10 has a very low transmission ratio. Moreover, it is possible to minimize a height of the electrical drive 5 and thereby a height h of the drive unit 3.

With the intention to realize a drive unit 3 with small dimensions, the components of the drive unit 3 are disposed tightly and partially nested into each other. Thereby, in particular the electrical drive 5 and the output 6 are affixed directly next to each other, wherein the connecting gear system 10 is disposed above the construction space of the electrical drive 5 and of the output 6. The blocking unit 9 in turn it disposed tightly to the output 6 and below the construction space of the gear system 10. Thus, a compact design of the drive unit 3 is provided.

The support element 11 represents thus preferably both an attachment and a housing for the electrical drive 5, the output 6, the gear system 10, the control device 7, the blocking unit 9, and the power supply unit 8. The drive unit 3 thus includes in addition to a small construction space requirement, furthermore the advantage of the mentioned components of the drive unit 3 not requiring their own housing. Moreover, the integrative construction method allows for foregoing cabling or at least to minimize the cabling requirement.

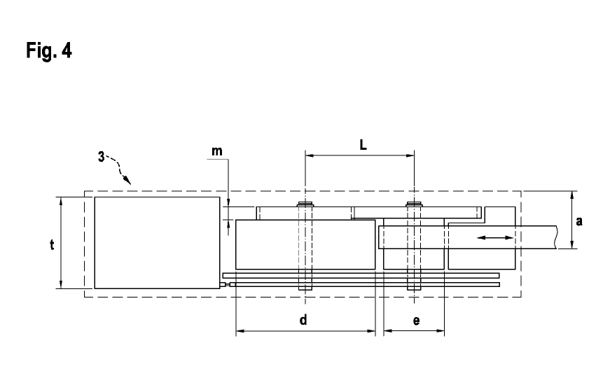

FIG. 4 shows another diagrammatical illustration of the drive unit 3, wherein the structure of the drive unit 3 shown in FIG. 4 is identical to the structure of the drive unit 3 of FIG. 3.

FIG. 4 reveals the above-described first stationary axis 15 has a center distance L to the second stationary axis 16. The center distance is calculated in particular from half the sum of the diameter d of the electrical drive 5 and the diameter e of the output 6.

This structure allows for a simple and therefore cost-effective manufacturing of a shaft-less motor having a high torque. Preferably, the torque of the electrical drive 5 amounts to at least 2 Nm, in particular to at least 4 Nm. Thereby, a low transmission is required for the gear system 10, preferably the transmission amounts to 1.1 to 4. In particular, the gear system 10 is a helical gear stage or a belt wheel gear stage, which both are very efficient.

Based on such a low transmission of the gear system 10, the drive unit 3 shows almost no self-locking. This means, if required, the door leaves 4 can be likewise displaced manually. Moreover, the low self-retention reduces the risk of blocking.

Finally, on account of the high torque, the electrical drive 5 requires very low revolutions for its operation. Preferably, maximum operating revolutions of the electrical drive amount to a maximum of 1500 min⁻¹, preferably to a maximum of 1200 min⁻¹, and in particular to a maximum of 1000 min⁻¹. Therefore, the electrical drive 5 is very quiet.

Furthermore, for a compact structure, it is intended that the diameter d of the electrical drive 5 amounts to 85 millimeters, whereas the diameter e of the output 6 amounts to 37 millimeters. The center distance L between the first stationary axis 15 and the second stationary axis 16 thus amounts to 67 millimeters.

A helical gear height m of the gear system 10 amounts in particular to 8 millimeters. In case the gear system 10 includes a belt stage, the belt height amounts in particular to 14 millimeters. This allows for realizing a very small drive unit 3, whereby a depth t of the drive unit 3 amounts to a maximum of 60 millimeters. Based on a distance a between the belt 21 and a back side of the drive unit 3, i.e. a side of the drive unit 3 which points to a mounting surface, to which the drive unit 3 is mounted or can be mounted, of a maximum of 30 millimeters, in particular preferred of a maximum of 20 millimeters, a very flat construction method is possible. A flat construction method means in particular that the drive unit 3 rises very little off a mounting surface, for example off a wall.

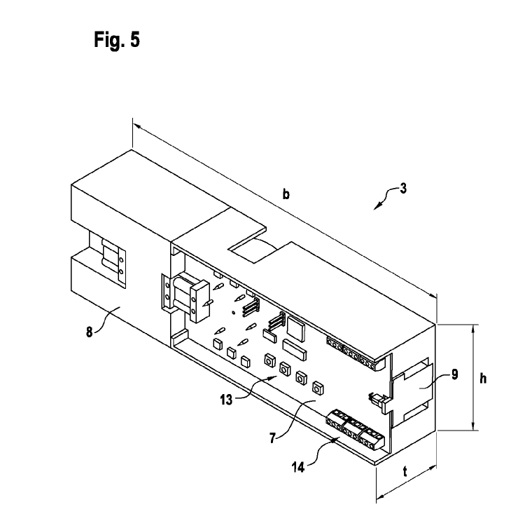

The integrative construction method of the drive unit 3 is in addition shown in FIG. 5. It can thus be seen that in addition to representing the supporting function, the support element 11 also represents a housing for the components of the drive unit 3. Just the power supply unit 8 is attached as a separate structural component with its own housing to the support 11.

A width b of the drive unit 3 amounts to a maximum of 400 millimeters, preferably to a maximum of 350 millimeters, and particularly preferred to a maximum of 300 millimeters, whereas a height h of the drive unit 3 amounts to a maximum of 90 millimeters. The depth t of the drive unit 3 has already been described with a maximum of 60 millimeters. Obviously, the drive unit 3 is designed to be very compact and space saving, nevertheless offers enough power for moving the door leaves 4.

Disposition of the Control Device

In the following, a second, a third, a fourth and a fifth exemplary embodiment of the disclosure will be described. In the Figures corresponding thereto the same reference numeral will indicate the same or similar structural components as in the first exemplary embodiment.

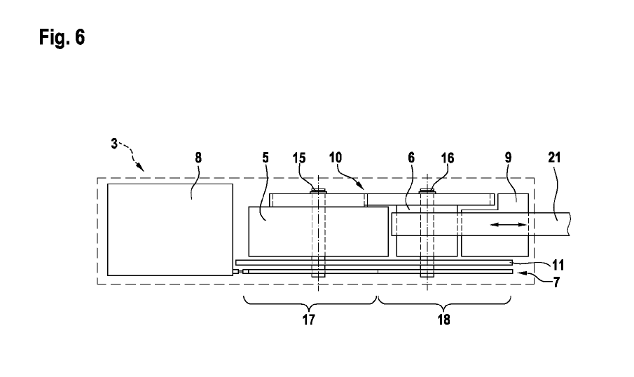

FIG. 6 shows a diagrammatical illustration of the drive unit 3 of the door drive 1 according to a second exemplary embodiment of the disclosure. In this case, the structure of the drive unit 3 of the door drive 1 according to the second exemplary embodiment is basically identical to the structure of the drive unit 3 of the door drive 1 according to the first exemplary embodiment.

The only difference to the first exemplary embodiment is found in the structure of the control device 7. Said device includes a first printed circuit card 17 and a second printed circuit card 18. The first printed circuit card 17 is in particular a motor control, whereas the second printed circuit card 18 is in particular a logic control.

The control device 7 is completely or at least partially disposed below the electrical drive 5. This arrangement allows for a good accessibility for an installation technician, because the manipulation elements 13 of the control device are accessible from the outside. Thereby, the control device 7 forms a frontal side of the mounted drive unit 3.

Preferably, a distance between the first printed circuit card 17 and a rotor of the electrical drive 5 amounts to a maximum of 10 millimeters. Moreover, the first printed circuit card includes magnetic sensors, which are able to scan a magnetic field of the rotor. The above-described small distance allows for disposing the magnetic sensors directly on the first printed circuit card 17, without creating interference for scanning the magnetic field of the rotor.

Based on the disposition of the first printed circuit card 17, in particular the utilization of magnetic sensors in SMD-construction type is utilized. This circumstance, on the one hand, translates into cost advantages for manufacturing the first printed circuit card 17. Moreover, a winding of the electrical drive 5 can be realized directly with the control device 7, in particular directly with the first printed circuit card 17. Therefore, linking the electrical drive 5 does not require any additional cabling. As an alternative, short cables for linking the electrical drive 5 to the control device 7 may be used.

The second printed circuit card 18 is a logic control, which preferably includes the manipulation elements 13. Moreover, the second printed circuit card 18 includes elements for logic evaluation. In the exemplary embodiment shown in FIG. 6, the first printed circuit card 17 is configured integrally with the second printed circuit card 18.

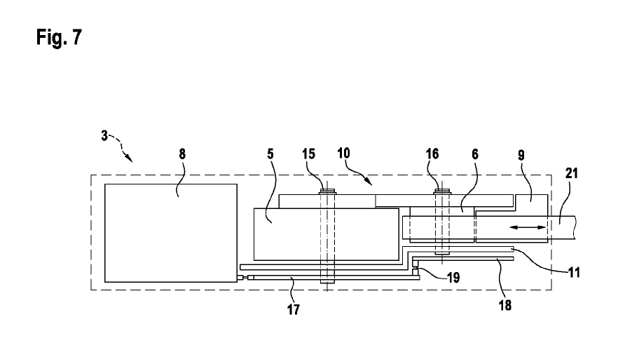

In the third exemplary embodiment shown in FIG. 7, the first printed circuit card 17 and the second printed circuit card 18 are separate structural components, which are connected via a contacting element 19. The contacting element 19 is a plug-in element, which electrically connects the first printed circuit card 17 to the second printed circuit card 18. Moreover, the first printed circuit card 17 and the second printed circuit card 18 are disposed at different heights or levels such as to provide for a large construction space for the manipulation elements 13 or for additional connection plugs. The second printed circuit card 18 is for this purpose placed further into the drive unit 3 than the first printed circuit card 17.

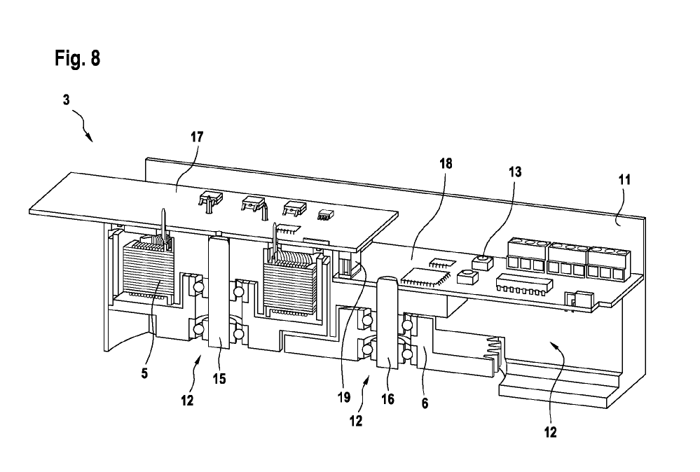

FIG. 8 shows likewise the drive unit 3 of the door drive 1 according to the third exemplary embodiment, which clearly reveals the increased construction space for the manipulation elements 13. Moreover, it is visible that the support element 11, at least partially, also represents a housing for the first printed circuit card 17 and for the second printed circuit card 18.

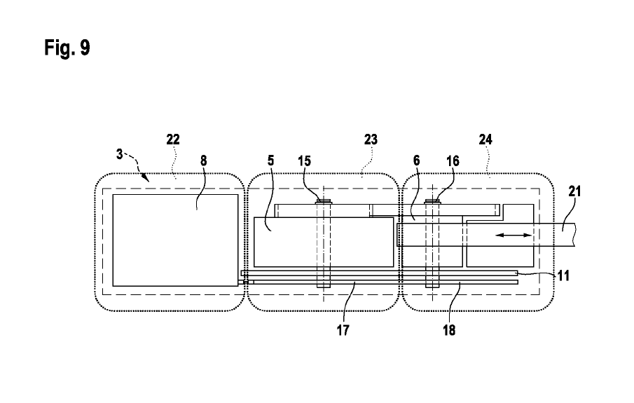

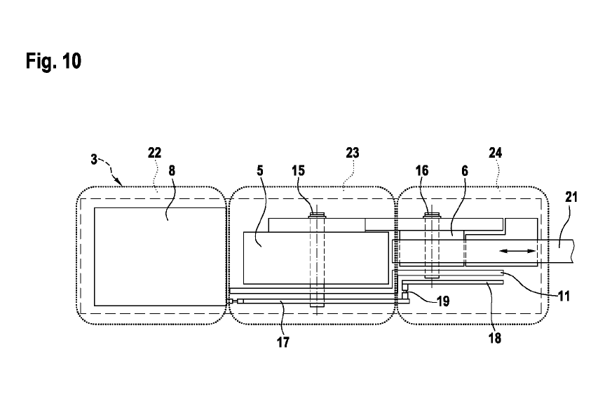

FIG. 9 shows a further illustration of the drive unit 3 of the door drive 1 according to the second exemplary embodiment. Finally, FIG. 10 shows an additional illustration of the drive unit 3 of the door drive 1 according to the third exemplary embodiment. Both FIG. 9 and FIG. 10 reveal that the respective shown drive units 3 can be subdivided into three sections.

High voltages are applied in the first section 22. This means, in particular the power supply unit 8 is disposed here. In the first section 22, preferably the power supply voltage of 230 VAC is present, whereas only low currents of less than two ampere are flowing. This arrangement translates into a maximum electrical capacity of approximately 380 watt. The power supply unit 8 converts the supply voltage into an operational voltage of 24 VDC and transmits the latter to the second section 23 of the drive unit 3.

In the second section 23 a very low operational voltage of 24 VDC is applied, whereas high motor currents of more than ten ampere are present. The motor currents are in particular required for supplying the electrical drive 5. Moreover, the first printed circuit card 17, which comprises the necessary electrical components for activating the electrical drive 5, is located in the second section 23.

Based on the high motor currents, within the second section 23, the maximum electrical capacity amounts to approximately 380 W. The first printed circuit card 17 switches the motor currents preferably depending on the position of the rotor of the electrical drive 5, whereby an electronical commutation can be realized. The electronical commutation is monitored by the second printed circuit card 18 having the logic control.

The second printed circuit card 18 is disposed in a third section 24 of the drive unit 3. In the third section 24, again the operational voltage of 24 VDC is applied, wherein just low switching currents of less than a few ampere flow.

Thus, the entire logic control of the drive unit 3 is located in the third section 24. The latter comprises in particular the manipulation elements 13 and preferably various connecting elements for additional sensors or switches. Based on information and/or on signals, which act upon the door drive 1 from outside, the logic control determines the travel cycle of the door leaves 4 and correspondingly controls the motor control of the first printed circuit card 17. Just very low voltages and currents are required for this purpose. The information and/or signals acting on the door drive 1 from outside comprise in particular a velocity and position of the door leaves 4, an obstacle between the door leaves 4, the presence of a fire, or the signals of door sensors.

By subdividing the drive unit 3 into the first section 22, the second section 23, and the third section 24, the drive unit 3 experiences a grading from high to low electrical capacities. Moreover, a separation between the power component and the logic component is made possible, whereby interference based on electromagnetic radiation can be reduced or prevented.

Disposition of the Drive Unit

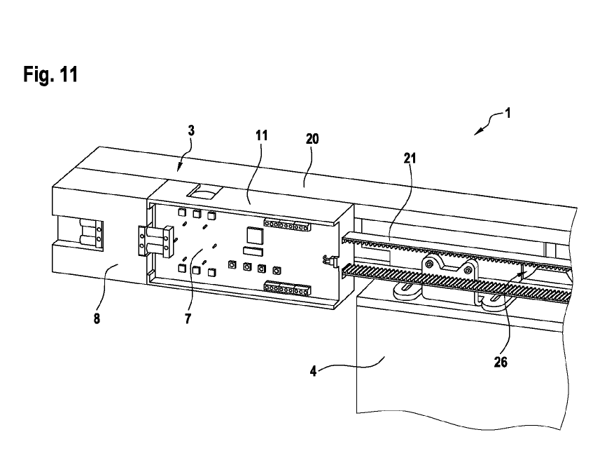

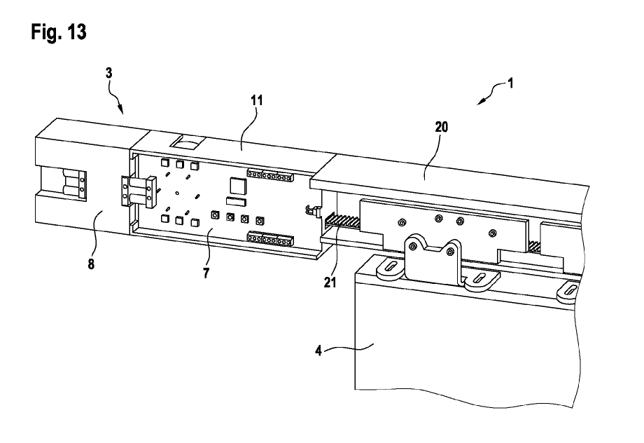

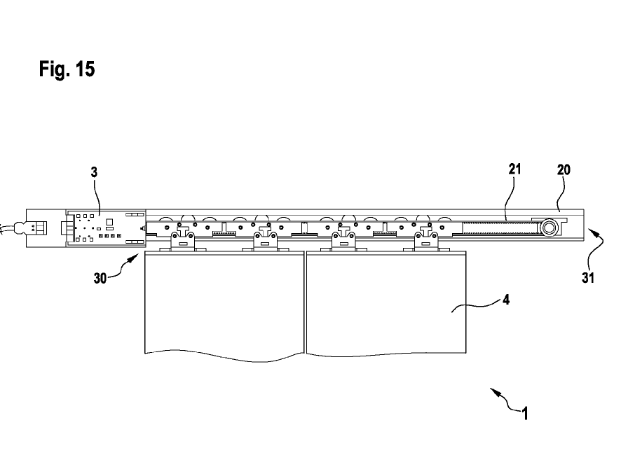

FIG. 11 shows a diagrammatical detailed view of the door drive 1 according to the first exemplary embodiment. In this case, it can be seen that the drive unit 3 is disposed at a frontal surface of the drive profile 20. As an alternative thereto, the drive unit 3, as shown in the fourth exemplary embodiment in FIG. 13, is disposed at a frontal face of the drive profile 20. The drive unit 3 is thereby universally applicable In particular, the drive unit 3 allows for realizing a plurality of different door drives 1. This circumstance will be described later with reference to the FIGS. 15, 16 and 17.

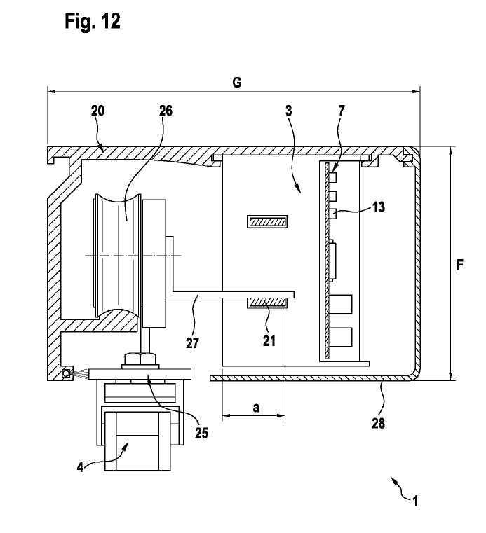

FIG. 12 shows an alternative view of the door drive 1 of FIG. 11. The door drive 1 includes the drive profile 21, the drive unit 3 being disposed at the lateral surface thereof. Moreover, the door leaves 4 are supported at the drive profile 21, in that the door leaves 4 are connected to at least one running roller 26 via a door connection 25. The running roller 26 is guided within the drive profile 21.

Thus, said side of the drive unit 3, on which the control device 7 is disposed, points away from the drive profile 21, whereas the opposite side of the drive unit 3 points towards the running rollers 26 of the door leaves 4. The manipulation elements 13 of the control device 7 are therefore easily accessible. A cover 28 is covering both the drive unit 3 and the drive profile 21.

Moreover, the door connection 25 is connected to a driver element 27. The driver element 27 engages in the belt 21 and is thereby movable by means of the drive unit 3. The door leaves 4 are therefore displaceable by means of the drive unit 3.

According to the first exemplary embodiment, the door drive 1 has an overall depth G of 160 millimeters and an overall height F of 100 millimeters. The belt 21 passes in such a way through the drive unit 3 that the distance a, between the belt 21 and the back side of the drive unit 3 oriented towards the running roller 26, amounts to 27 millimeters and thereby amounts to less than 30 millimeters. As an alternative, the door drive 1 may be configured in such a way that an overall height F just amounts to 70 millimeters. In this case, door leaves 4 of lesser mass need to be moved.

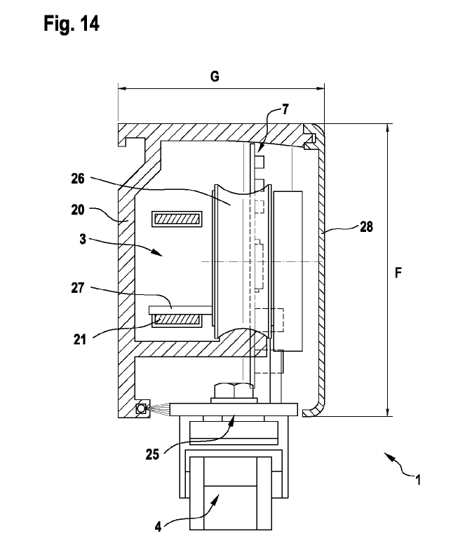

FIG. 14 shows an alternative view of the door drive 1 of FIG. 13. As already described above, the same drive unit 3 as in the first exemplary embodiment allows for conceiving another door drive 1. For this purpose, the drive unit 3 is disposed at a frontal face of the drive profile 20. Analogously to the first exemplary embodiment, the overall height F of the door drive 1 thus amounts to 100 millimeters. However, the overall depth G of the door drive 1 according to the fourth exemplary embodiment is reduced to 70 millimeters.

Like in the first exemplary embodiment, the drive unit 3 of the fourth exemplary embodiment includes manipulation elements (which are not visible in FIG. 14), which are directed to an installation technician and can be covered by means of the cover 28. The back side of the drive unit 3 opposite the manipulation elements points to the same mounting surface as the back side of the drive profile 20, for example to a wall, at which the door drive 1 is mounted.

The surface of the drive unit 3, at which the belt 21 exits the drive unit 3, points towards the running rollers 26 of the door leaves 4. Therefore, the running rollers move towards or away from said surface of the drive unit 3.

In the fourth exemplary embodiment, the belt 21 is guided behind the running rollers 26, and, compared to the first exemplary embodiment, on the opposite side of the running rollers 26. The door connection 25 is again connected to a driver element 27, which engages in the belt 21. The described disposition of the belt 21 allows for a very compact embodiment of the door drive 1 with the specified dimensions.

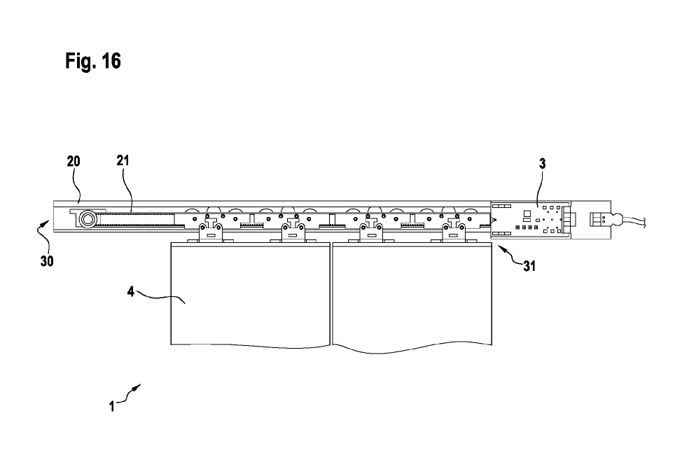

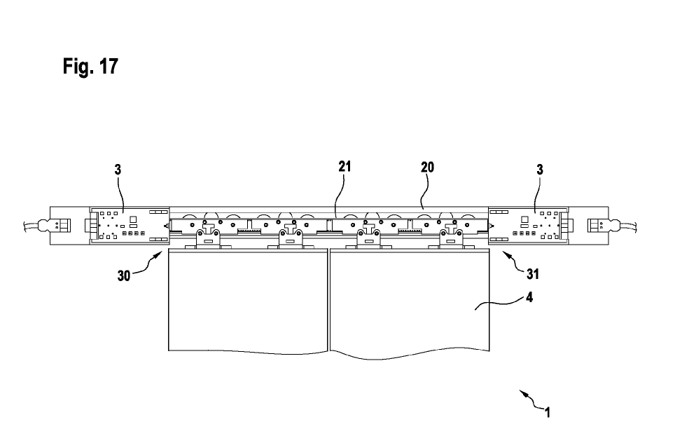

FIG. 15 shows again the door drive 1 according to the first exemplary embodiment. The FIGS. 16 and 17 show a fifth and a sixth exemplary embodiment of the door drive 1. In this case, same reference numerals indicate again same or similar structural components.

The only difference between the first exemplary embodiment, the fifth exemplary embodiment, and the sixth exemplary embodiment is in the disposition of the drive unit 3. The drive profile thus includes a first end 30 and a second end 31. Based on the utilization of a revolving belt 21, it is therefore possible to insert the drive unit 3 at the first end 30 and/or at the second end 31 in a flexible manner.

In the first exemplary embodiment shown in FIG. 15, the drive unit 3 is disposed at the first end 30 of the drive profile 20, whereas in the second exemplary embodiment shown in FIG. 16, the drive unit 3 is disposed at the second end 31 of the drive profile 20. Thereby, the door drive 1 can be optionally realized according to the given available space or according to other circumstances.

Two drive units 3 are employed in the sixth exemplary embodiment of the door drive 1 shown in FIG. 17, wherein one drive unit 3 is disposed at the first end 30 of the drive profile 20 and the other drive unit 3 is disposed at the second end 31 of the drive profile 20. As already described above, the drive unit 3 has a very low self-retention, such that in operation the drive units 3 do not interfere with each other, if just one of the two drive units 3 is utilized for driving the door leaves 4. As an alternative, both drive units 3 can be employed for driving the door leaves 4, such as to be able to reliably move heavy door leaves 4 in a well functioning manner. In any case, provision of two drive units 3 realizes a redundant door drive 1. Should one of the drive units 3 fail, the other drive unit 3 is available to drive the door leaves 4.

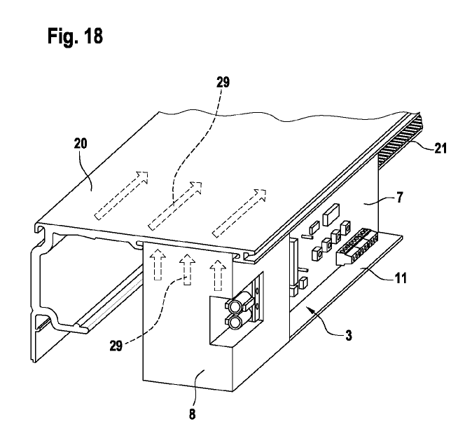

Finally, FIG. 18 shows a last diagrammatical view of the door drive 1 according to the first exemplary embodiment. In this case, it can be seen that the drive profile 20 represents a cooling body for the drive unit 3. This disposition can be even improved if a heat-conducting material is inserted between the drive profile 20 and the drive unit 3. Thereby, heat is conducted 29 from the drive unit 3 into the drive profile 20. Based on the seize of the drive profile 20, thus sufficient cooling of the drive unit 3 is guaranteed.

The support element 11 of the drive unit 3 is in particular connected to the drive profile 20. As the support element 11 supports moreover the electrical drive 5, an optimum heat-conduction from the electrical drive 5 is provided via the support element 11 to the drive profile 20. Thereby, a comprehensive cooling of the electrical drive 5 is realized, which likewise allows for realizing high performances in the electrical drive 5. In this way, no additional cooling element is required for the electrical drive 5.

The Figures and the above description clearly reveal that, on the one hand, the door drive 1 according to the disclosure allows for a flexible utilization and, on the other hand, can be manufactured cost-effectively. Moreover, the door drive 1 allows for a safe and reliable operation. Finally, the door drive 1 requires very little construction space.

1. A door drive, including a drive unit, wherein the drive unit comprises:
at least one electrical drive,
an output, drivable by the electrical drive and connectable to a transmission device for moving door leaves,
a control device, and
a support element,
wherein the support element includes a plurality of recesses, in which the electrical drive, the output and the control device are disposed.

2. The door drive according to claim 1, wherein the drive unit comprises a power supply unit disposed in a recess of the support element or at an external side of the support element.

3. The door drive according to claim 1, wherein the drive unit comprises blocking unit, wherein the blocking unit is disposed in a recess of the support element or at an external side of the support element.

4. The door drive according to claim 1, wherein the drive unit includes a rectangular body, wherein a height of the drive unit amounts to a maximum of 120 millimeters for an overall weight of the door leaves to be moved of at least 600 kilograms.

5. The door drive according to claim 1, wherein the electrical drive includes a first stationary axis and the output includes a second stationary axis.

6. The door drive according to claim 5, wherein the first stationary axis and the second stationary axis are attached to the support element.

7. The door drive according to claim 5, wherein the first stationary axis is disposed parallel to the second stationary axis, wherein a center distance between the first stationary axis and the second stationary axis corresponds to at least half the sum of diameter of the electrical drive and the diameter of the output.

8. The door drive according to claim 7, wherein the first stationary axis and the second stationary axis are oriented at a right angle or essentially at a right angle to a displacement direction of the door leaves.

9. The door drive, including a drive unit, wherein the drive unit comprises:
at least one electrical drive with a longitudinal axis,
an output, which is driven by the electrical drive and is connectable to a transmission device for moving door leaves, and
a control device including at least one first printed circuit card and at least one second printed circuit card,
wherein, at least the first printed circuit card is disposed vertically with regard to the longitudinal axis of the electrical drive and at least partially overlapping with the electrical drive.

10. The door drive according to claim 9, wherein the first printed circuit card comprises the electrical drive and the second printed circuit card comprises a logic control.

11. The door drive according to claim 10, wherein a distance between the first printed circuit card and a rotor of the electrical drive amounts to a maximum of 20 millimeters.

12. The door drive according to the claim 10, wherein the first printed circuit card is connected to the second printed circuit card via a contacting element.

13. The door drive according to claim 9, wherein the drive unit comprises a power supply unit, wherein the first printed circuit card is disposed between the second printed circuit card and the power supply unit.

14. The door drive including a drive profile and at least one drive unit affixed to the drive profile, wherein the drive unit comprises:
at least one electrical drive with a longitudinal axis,
an output which can be driven by means of the electrical drive, and
a control device,
wherein a transmission device, which can be driven in particular by means of a belt, is disposed within the drive profile,
wherein the door leaves can be supported at the drive profile and are displaceable by means of the transmission device, and
wherein an overall depth of the door drive, which is measured in particular parallel to the longitudinal axis and/or vertically to the door leaves, amounts to a maximum of 160 millimeters.

15. The door drive according to claim 14, wherein a first drive unit is affixed to a first end of the drive profile and/or a second drive unit is affixed to a second end of the drive profile, wherein the first drive unit is configured identical to the second drive unit.

16. The door drive according to claim 14, wherein a heat conducting material is inserted between the drive unit and the drive profile.

17. The door drive according to claim 14, wherein the drive unit is affixed to a frontal side or to a longitudinal side of the drive profile.

18. The door drive according to claim 14, wherein a distance between a back side of the drive unit which, extend parallel to the transmission device, and the transmission device amounts to a maximum of 30 millimeters.

19. The door drive according to claim 14, wherein the drive unit is attached to the drive profile such that the control device points away from the drive profile.

20. The door drive according to claim 1, wherein the drive unit includes a rectangular body, wherein a height of the drive unit amounts to a maximum of 90 millimeters for an overall weight of the door leaves to be moved of at least 400 kilograms, and to a maximum of 60 millimeters for an overall weight of the door leaves to be moved of at least 240 kilograms, and to a depth of the drive unit of a maximum of 60 millimeters.
